(19) United States
(12) Patent Application Publication
(10) Pub. No.: US 2026/0088019 A1
(43) Pub. Date: Mar. 26, 2026

(54) METHOD FOR TRAINING WAKE-UP WORD DETECTION MODEL, WAKE-UP WORD DETECTION METHOD, AND NON-TRANSIENT COMPUTER-READABLE STORAGE MEDIUM

(71) Applicant: Beijing Zitiao Network Technology Co., Ltd., Beijing (CN)

(72) Inventors: Wenzhi FAN, Beijing (CN); Yangfei XU, Beijing (CN)

(21) Appl. No.: 19/340,596

(22) Filed: Sep. 25, 2025

(30) Foreign Application Priority Data
Sep. 26, 2024 (CN) 202411355302.0

(51) Int. Cl. G10L 15/06; G10L 15/08; G10L 15/16

(52) U.S. Cl. CPC G10L 15/063; G10L 15/16; G10L 2015/088

(57) ABSTRACT

The present disclosure relates to a method for training a wake-up word detection model, a wake-up word detection method, and a non-transient computer-readable storage medium. The method for training a wake-up word detection model includes: acquiring a sample dataset constructed based on at least one wake-up word, an audio dataset, and a speech recognition dataset; performing first-stage training on an acoustic encoder in an initial model with the audio dataset, and performing first-stage training on a speech recognition model with the speech recognition dataset; and obtaining a wake-up word detection model by performing stepwise training on the acoustic encoder after the first-stage training, an audio feature extractor, and a wake-up word predictor in the initial model, with the sample dataset and the speech recognition model after the first-stage training.

### CROSS-REFERENCE TO RELATED APPLICATION

The present disclosure claims the priority and benefits of Chinese patent application No. 202411355302.0 entitled “WAKE-UP WORD DETECTION METHOD, MODEL TRAINING METHOD, APPARATUS, DEVICE AND MEDIUM” and filed in Chinese Patent Office on Sep. 26, 2024, the entirety of which is incorporated into the present disclosure by reference.

### TECHNICAL FIELD

The present disclosure relates to a method for training a wake-up word detection model, a wake-up word detection method and a non-transient computer-readable storage medium.

### BACKGROUND

As a mainstream trigger mechanism in human-computer interaction processes, wake-up word detection is widely applied in various fields such as consumer electronics, conference communications, and in-car audio systems. Most existing smart devices support one or more preset wake-up words and also allow users to customize their own wake-up words. The related art for wake-up word detection requires a large amount of audio data and involves certain post-processing and calibration steps, leading to a complex process with low recall rates and high instances of false awakenings.

### SUMMARY

The embodiments of the present disclosure provide a method for training a wake-up word detection model, comprising:
acquiring a sample dataset constructed based on at least one wake-up word, an audio dataset, and a speech recognition dataset;
performing first-stage training on an acoustic encoder in an initial model with the audio dataset, and performing first-stage training on a speech recognition model with the speech recognition dataset; and
obtaining a wake-up word detection model by performing stepwise training on the acoustic encoder after the first-stage training, an audio feature extractor, and a wake-up word predictor in the initial model, with the sample dataset and the speech recognition model after the first-stage training.

The embodiments of the present disclosure further provide a wake-up word detection method, comprising:
acquiring target audio data;
detecting the target audio data with a wake-up word detection model, and determining target detection probabilities for at least one wake-up word in the target audio data, wherein the wake-up word detection model being obtained through the method for training the wake-up word detection model provided in the embodiments of the present disclosure; and
determining a wake-up word detection result of the target audio data based on the target detection probabilities.

The embodiments of the present disclosure further provide a training apparatus for a wake-up word detection model, comprising:
a data module for acquiring a sample dataset constructed based on at least one wake-up word, an audio dataset, and a speech recognition dataset;
a first training module for performing first-stage training on an acoustic encoder in an initial model with the audio dataset, and performing first-stage training on a speech recognition model with the speech recognition dataset; and
a second training module for obtaining a wake-up word detection model by performing stepwise training on the acoustic encoder after the first-stage training, an audio feature extractor, and a wake-up word predictor in the initial model, with the sample dataset and the speech recognition model after the first-stage training.

The embodiments of the present disclosure provide a wake-up word detection apparatus, comprising:
an acquisition module for acquiring target audio data;
a detection module for detecting the target audio data using a wake-up word detection model, and determining target detection probabilities for at least one wake-up word in the target audio data, wherein the wake-up word detection model being obtained through the method for training the wake-up word detection model provided in the embodiments of the present disclosure; and
a result module for determining a wake-up word detection result of the target audio data based on the target detection probabilities.

The embodiments of the present disclosure further provide an electronic device, comprising: a processor; and a memory for storing instructions executable by the processor, reading the executable instructions from the memory and executing the instructions to implement the method provided in the embodiments of the present disclosure.

The embodiments of the present disclosure further provide a computer-readable storage medium storing a computer program therein, wherein the computer program is configured to perform the method for training the wake-up word detection model or the wake-up word detection method provided in the embodiments of the present disclosure.

### BRIEF DESCRIPTION OF DRAWINGS

With reference to the accompanying drawings and the following detailed description, the above and other features, advantages and aspects of embodiments of the present disclosure will become more apparent. Throughout the drawings, the same or similar reference numerals indicate the same or similar elements. It should be understood that the drawings are schematic, and originals and elements are not necessarily drawn to scale.

FIG. 1 is a flowchart of a method for training a wake-up word detection model according to an embodiment of the present disclosure;

FIG. 2 is a flowchart of a wake-up word detection method according to an embodiment of the present disclosure;

FIG. 3 is a schematic structural diagram of a training apparatus for a wake-up word detection model according to an embodiment of the present disclosure;

FIG. 4 is a schematic structural diagram of a wake-up word detection apparatus according to an embodiment of the present disclosure; and

FIG. 5 is a schematic structural diagram of an electronic device according to an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between multiple apparatuses in the embodiments of the present disclosure are only for illustrative purposes, and are not intended to limit the scope of these messages or information.

The accuracy of wake-up word detection is affected by surrounding environmental noise and room reverberation. To address this issue, data augmentation is typically performed during the training of a wake-up word detection model to enhance noise robustness. Additionally, preprocessing steps such as noise reduction and dereverberation are applied to audio before wake-up word detection to improve the quality of wake-up audio. In the related art, training a wake-up word usually relies on a large amount of audio data in various timbres for preset wake-up words. The collection of the training data is time-consuming, costly, and challenging. Under the cold-start conditions where the training data is lacking, it is challenging for wake-up word technology to deliver satisfactory detection results. The wake-up word detection technology based on models for sequence-to-sequence learning tasks can be used for detection for customized wake-up words. However, as a non-end-to-end wake-up solution, this technology typically requires additional decoding post-processing steps and calibration of a scoring mechanism for target wake-up words, to achieve the desired wake-up effect. In summary, wake-up word detection in the relates art involves a complex process with low recall rates and high instances of false awakenings.

To solve the above problems, embodiments of the present disclosure provide a method for training a wake-up word detection model and a wake-up word detection method, which will be introduced below based on specific embodiments.

FIG. 1 is a flowchart of a method for training a wake-up word detection model according to an embodiment of the present disclosure. The method may be executed by a training apparatus for a wake-up word detection model, and the apparatus may be realized by software and/or hardware, and is generally integrated in an electronic device. As shown in FIG. 1, the method includes the following steps.
Step 101: acquiring a sample dataset constructed based on at least one wake-up word, an audio dataset, and a speech recognition dataset.

Here, the wake-up word may be a specific term used to activate the functions of electronic devices. When a user utters the wake-up word, the electronic device can be awakened from a sleep mode, being prepared to receive and process subsequent voice commands. The design of the wake-up word allows users to quickly wake up the device when needed without physical interaction. Wake-up words may be user-defined, supporting scenarios where customized wake-up words are used, for example, “Little Assistant for A” may be used as the wake-up word for an electronic device A with voice activation capabilities. User-defined wake-up words can be registered through text registration. Additionally, wake-up words may also be fixed, meaning they are preset by the system. There is no limit to the number of wake-up words, which can be one or multiple.

The sample dataset includes a plurality of samples, each including sample audio data, a text label for the sample audio data, and a wake-up word label indicating whether the sample audio data contains at least one wake-up word. The text label refers to the text corresponding to the spoken part within the audio data. The sample dataset may include a plurality of positive samples and a plurality of negative samples. The wake-up word label of each positive sample contains at least one wake-up word present in the corresponding sample audio data, and the wake-up word label of each negative sample indicates that the corresponding sample audio data does not include any wake-up words.

The audio dataset may include a plurality of pieces of unlabeled audio data for training an acoustic encoder. Each piece of the unlabeled audio data contains speech with a large amount of data. For instance, the audio dataset may contain a plurality of pieces of audio data collected over more than 100,000 hours. The speech recognition dataset may be used to train a speech recognition model. For example, the speech recognition model includes a plurality of pieces of text data, each containing multiple sentences. During training, the input is one sentence, and the label is the subsequent sentence for the sentence. The amount of data of the audio dataset and the speech recognition dataset exceeds that of the sample dataset, as both the audio dataset and the speech recognition dataset are on a large scale, significantly surpassing the amount of data of the sample dataset.

Specifically, a wake-up word detection apparatus may acquire at least one wake-up word and construct a sample dataset based on the at least one wake-up word, and acquire an audio dataset and a speech recognition dataset, for example, from relevant databases.
Step 102: performing first-stage training on an acoustic encoder in an initial model with the audio dataset, and performing first-stage training on a speech recognition model with the speech recognition dataset.

Here, the initial model may be an untrained model. In an embodiment of the present disclosure, the initial model may include an audio feature extractor, an acoustic encoder, and a wake-up word predictor. The audio feature extractor may be a module that extracts features for audio data. For example, the audio feature extractor may adopt a Mel spectrogram coefficient extractor, a Mel frequency cepstral coefficient extractor, etc., with no specific limitations. Optionally, the audio feature extractor may be a single-channel feature extractor or a multi-channel feature extractor. The acoustic encoder may be a module that processes audio signals, encoding the audio signals to reduce the amount of data while preserving the quality of the original audio as much as possible. For example, the acoustic encoder may consist of fully connected layers, sequence network modules based on self-attention mechanisms, nonlinear activation functions, and normalization layers, which are merely examples. In an embodiment of the present disclosure, the acoustic encoder may further process the audio features extracted by the audio feature extractor from audio data to obtain an acoustic representation vector, which may have a specific dimension. Optionally, the acoustic encoder may include a down-sampling model to add down-sampling steps, thereby reducing the computational load of the network and minimizing information redundancy. The wake-up word predictor may be a module that predicts the probability of a wake-up word being present in a piece of audio data. For example, the wake-up word predictor may include pooling layers, fully connected layers, sigmoid activation functions, binary cross-entropy cost functions, and first-order gradient-based optimizers, which are merely examples. The speech recognition model is used to train the wake-up word detection model. In an embodiment of the present disclosure, the speech recognition model may be a deep learning model with a large parameter scale and complex structure, capable of providing higher performance and generalization ability when handling complex tasks. The speech recognition model can recognize the text corresponding to the audio data.

Specifically, the wake-up word detection apparatus can use the audio dataset to perform first-stage training on an acoustic encoder in an initial model, employing an unsupervised method for training. For example, a random projection quantizer may be used to map continuous speech signals to discrete labels, utilizing a cost function for training. Additionally, the speech recognition model can undergo first-stage training using the speech recognition dataset. For instance, when the speech recognition model includes a plurality of pieces of text data, the method for training may involve inputting multiple statements of each piece of text data in the speech recognition dataset, predicting the next statement based on one statement, with the next statement serving as the label. The cost function may be a cross-entropy, serving only as an example. Here, first-stage training may be the initial stage of a stepwise training process, where the speech recognition model and the acoustic encoder in the initial model are trained first. This enhances the accuracy of internal parameters and improves performance, effectively increasing the efficiency and accuracy of subsequent model training.
Step 103: obtaining a wake-up word detection model by using the sample dataset and the speech recognition model after the first-stage training to perform stepwise training on the acoustic encoder after the first-stage training, an audio feature extractor, and a wake-up word predictor in the initial model.

Here, the wake-up word detection model may be a model used to detect the probability of a specific wake-up word being present in the audio data, and thus determine whether the wake-up word exists based on the probability. In an embodiment of the present disclosure, the wake-up word detection model is used to determine detection probabilities for at least one wake-up word in a piece of audio data. The wake-up word detection model in an embodiment of the present disclosure may be obtained by training using the speech recognition model. The wake-up word detection model may be established through stepwise training, which may be understood as starting the training process with one module and progressively adding modules until all modules are trained. Employing a stepwise training approach allows the well-parameterized modules after training to continue participating in subsequent training, effectively enhancing the training effectiveness and accuracy of the model.

In an embodiment of the present disclosure, the initial model may include an audio feature extractor, an acoustic encoder, and a wake-up word predictor. When the wake-up word detection apparatus performs stepwise training on the speech recognition model associated with the initial model, it can utilize the sample dataset for second-stage training of the audio feature extractor, the acoustic encoder, and the speech recognition model, on the premise of the first-stage training. Subsequently, the sample dataset can be used for third-stage training of the audio feature extractor, the acoustic encoder, the wake-up word predictor, and the speech recognition model, continuing until convergence conditions are met. The trained initial model, which includes the audio feature extractor, the acoustic encoder, and the wake-up word predictor, is then identified as the wake-up word detection model.

In some embodiments, obtaining a wake-up word detection model by using the sample dataset and the speech recognition model after the first-stage training to perform stepwise training on the acoustic encoder after the first-stage training, an audio feature extractor, and a wake-up word predictor in the initial model may include: using the sample audio data and the text labels of each sample in the sample dataset to perform second-stage training on the audio feature extractor, and the acoustic encoder and the speech recognition model after the first-stage training; using the sample audio data and the wake-up word labels of each sample in the sample dataset to perform third-stage training on the audio feature extractor and the acoustic encoder after the second-stage training, and the wake-up word predictor in the initial model, while using the sample audio data and the text labels of each sample in the sample dataset to perform third-stage training on the audio feature extractor, the acoustic encoder, and the speech recognition model after the second-stage training; and determining the trained initial model as the wake-up word detection model.

Second-stage training may be the intermediate stage of the stepwise training process, and third-stage training may serve as the concluding stage. The stepwise training process, which includes first-stage training, second-stage training, and third-stage training, combined with the speech recognition model, can effectively enhance the training effectiveness and the accuracy of the model.

The wake-up word detection apparatus can utilize the sample audio data and the text labels of each sample in the sample dataset, with the sample audio data of each sample serving as the input and the text labels as the output to perform second-stage training on the audio feature extractor, and the acoustic encoder and the speech recognition model after the first-stage training. The cost function may be a cross-entropy.

Optionally, using the sample audio data and the wake-up word labels of each sample in the sample dataset to perform third-stage training on the audio feature extractor and the acoustic encoder after the second-stage training, and the wake-up word predictor in the initial model may include: inputting the sample audio data of each sample into the audio feature extractor and the acoustic encoder after the second-stage training, to output corresponding acoustic representation vectors; inputting the acoustic representation vectors of each sample into the wake-up word predictor to output sample detection probabilities for at least one wake-up word in each piece of sample audio data; and performing cost calculation and parameter updating based on the sample detection probabilities and the corresponding wake-up word labels of each sample until convergence conditions are met.

Further, the wake-up word detection apparatus utilizes the sample dataset to perform third-stage training on the audio feature extractor, the acoustic encoder, the wake-up word predictor, and the speech recognition model. The third-stage training process may include two parts. The first part involves training the audio feature extractor and the acoustic encoder which have undergone second-stage training, and the wake-up word predictor, using the sample audio data and the wake-up word labels of each sample, with the sample audio data serving as the input and the wake-up word labels as the output. Corresponding acoustic representation vectors are obtained by inputting the sample audio data of each sample into the audio feature extractor and the acoustic encoder after the second-stage training. Sample detection probabilities for at least one wake-up word in each piece of sample audio data are obtained by inputting the acoustic representation vectors into the wake-up word predictor. The sample detection probability includes a sub-probability that each wake-up word is contained within sample audio data, and the sample detection probability may be considered as a posterior probability. Cost calculation and parameter updating are performed based on the sample detection probabilities and the corresponding wake-up word labels of each sample. The cost calculation may be conducted alongside the results of the speech recognition model, specifically implemented through a cost function, continuing until convergence conditions are met.

The second part involves using the sample audio data and the text labels of each sample to perform third-stage training on the audio feature extractor, the acoustic encoder and the speech recognition model after the second-stage training. Corresponding acoustic representation vectors are obtained by inputting the sample audio data of each sample into the audio feature extractor and the acoustic encoder after the second-stage training. By inputting the acoustic representation vectors into the speech recognition model, prediction probabilities for the text labels for the sample audio data are obtained. During the first part of training, the wake-up word predictor outputs the sample detection probabilities, while in the second part of training, the speech recognition model outputs the prediction probabilities for the text labels by the sample audio data. After obtaining the outputs from the two parts, an objective cost function is trained, which may be defined as binary cross-entropy, represented as L=a1*L_asr+a2*L_kws, where a1 and a2 are the weights for the respective cost functions. For instance, a1=a2=1, L_asr represents the cost function for the second part, calculated using the prediction probabilities for the text labels in the sample audio data and the text labels, while L_kws denotes the cost function for the first part, calculated using the sample detection probabilities and the wake-up word labels. After calculating the objective cost function, the gradient information for all parameters is obtained through backpropagation, and an optimizer is used to update the parameters. Traversing is performed multiple times over the training data until the value of the objective cost function no longer shows significant decline, achieving network convergence. At this point, the trained initial model, which includes the audio feature extractor, the acoustic encoder, and the wake-up word predictor, is identified as the wake-up word detection model.

Optionally, the speech recognition model mentioned above may also be a model that has been trained on a large-scale dataset. This approach unifies complex models and the speech recognition system from the perspective of framework. The model training fully leverages extensive audio and text data, and the model with a large amount of parameters guarantees the recognition and comprehension capabilities of the model, resulting in higher accuracy and more intelligent speech recognition performance as a whole. Consequently, the wake-up word detection model trained using the speech recognition model can achieve improved accuracy.

In this scheme, employing a speech recognition model trained on a large dataset for multi-task training using a stepwise training approach can yield a wake-up word detection model with a simpler training process. This can detect customized wake-up words or command phrases in human-computer interaction scenarios, leading to higher recall rates and fewer false awakenings. Additionally, with fewer wake-up word characters (e.g., two characters), good results in both recall rates and false alarm counts can be achieved.

The training scheme for the wake-up word detection model provided in an embodiment of the present disclosure includes: acquiring a sample dataset constructed based on at least one wake-up word, an audio dataset, and a speech recognition dataset; using the audio dataset to perform first-stage training on an acoustic encoder in an initial model, and using the speech recognition dataset to perform first-stage training on a speech recognition model; using the sample dataset and the speech recognition model after the first-stage training to perform stepwise training on the acoustic encoder after the first-stage training, an audio feature extractor, and a wake-up word predictor in the initial model, to obtain a wake-up word detection model. By employing the aforementioned technical scheme, after performing first-stage training on the acoustic encoder and the speech recognition model in the initial model, the speech recognition model obtained after the first-stage training can be used for stepwise training of the initial model to derive the wake-up word detection model. The end-to-end stepwise training results in a wake-up word detection model without the need for post-processing, calibration, or other steps, streamlining the workflow. Additionally, due to the high accuracy and processing performance of the speech recognition model, the wake-up word detection model trained with the speech recognition model achieves a higher recall rate and fewer false awakenings, along with greater accuracy in wake-up word detection.

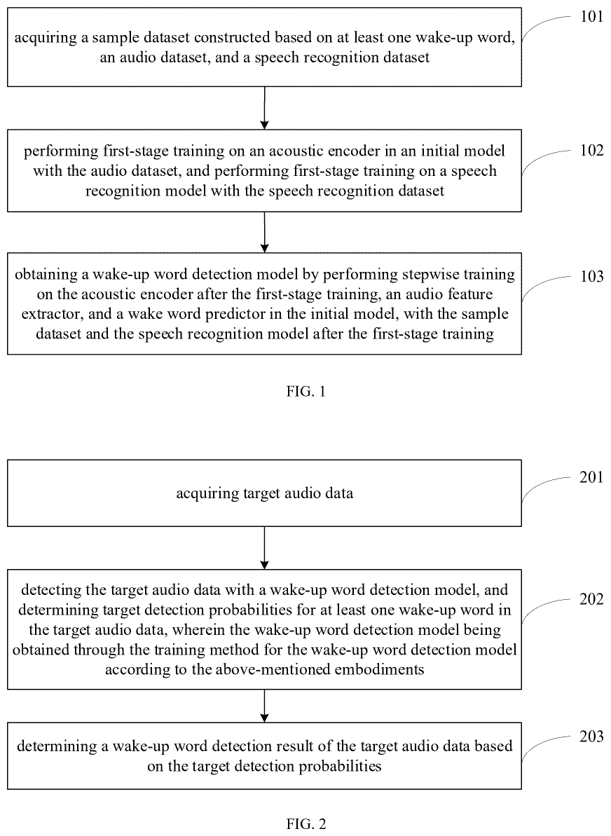

FIG. 2 is a flowchart of a wake-up word detection method according to an embodiment of the present disclosure. The method may be executed by a wake-up word detection apparatus, and the apparatus may be realized by software and/or hardware, and is generally integrated in an electronic device. As shown in FIG. 2, the method includes the following steps.
Step 201: acquiring target audio data.

In an embodiment of the present disclosure, wake-up word detection may be understood as the process of determining whether specific wake-up words are present in audio data. Specifically, it involves detecting audio data that includes the specific wake-up words among multiple pieces of audio data. The target audio data may be any audio data requiring wake-up word detection, with no restrictions on quantity or source. For example, the target audio data may consist of one or more pieces of audio data captured by electronic devices.
Step 202: using a wake-up word detection model to detect the target audio data, and determining target detection probabilities for at least one wake-up word in the target audio data, the wake-up word detection model being obtained through the method for training the wake-up word detection model as described in the above embodiment.

Here, the wake-up word detection model may be a model used to detect the probability of a specific wake-up word being present in audio data, and thus determine whether the wake-up word exists based on the probability. In an embodiment of the present disclosure, the wake-up word detection model is used to determine detection probabilities for at least one wake-up word in a piece of audio data. In an embodiment of the present disclosure, the wake-up word detection model may be obtained through the method for training the wake-up word detection model as described in the above embodiment, and no further elaboration will be provided here. Stepwise training may be understood as starting the training process with one module and progressively adding modules until all modules are trained. Employing a stepwise training approach allows the well-parameterized modules after training to continue participating in subsequent training, effectively enhancing the training effectiveness and accuracy of the model. A wake-up word may be a specific term used to activate the functions of electronic devices. Wake-up words may be user-defined or fixed phrases, and there is no limit to the number of wake-up words, which may be one or multiple.

In some embodiments, the wake-up word detection model may include an audio feature extractor, an acoustic encoder, and a wake-up word predictor. Using a wake-up word detection model to detect the target audio data, and determining target detection probabilities for at least one wake-up word in the target audio data may include: inputting the target audio data and at least one wake-up word into the wake-up word detection model, specifically inputting the target audio data into the audio feature extractor and the acoustic encoder, to output a corresponding target acoustic representation vector; inputting the target acoustic representation vector into the wake-up word predictor to output at least one sub-detection probability for the at least one wake-up word in the target audio data; and determining a combination of the at least one sub-detection probability as a target detection probability.

The audio feature extractor may be a module that extracts features from audio data. For example, the audio feature extractor may adopt a Mel spectrogram coefficient extractor, a Mel frequency cepstral coefficient extractor, etc., with no specific limitations. Optionally, the audio feature extractor may be a single-channel feature extractor or a multi-channel feature extractor. The acoustic encoder may be a module that processes audio signals, encoding the audio signals to reduce the amount of data while preserving the quality of the original audio as much as possible. For example, the acoustic encoder may consist of fully connected layers, sequence network modules based on self-attention mechanisms, nonlinear activation functions, and normalization layers, which are merely examples. In an embodiment of the present disclosure, the acoustic encoder may further process the audio features extracted by the audio feature extractor from the audio data to obtain an acoustic representation vector, which may have a specific dimension. Optionally, the acoustic encoder may include a down-sampling model to increase down-sampling steps, thereby reducing the computational load of the network and minimizing information redundancy. The wake-up word predictor may be a module that predicts the probability of a wake-up word being present in a piece of audio data. For example, the wake-up word predictor may include pooling layers, fully connected layers, sigmoid activation functions, binary cross-entropy cost functions, and first-order gradient-based optimizers, which are merely examples.

The target acoustic representation vector may be an acoustic representation vector obtained through feature extraction and acoustic encoding processing of the target audio data. The sub-detection probability may represent the specific probability that the target audio data includes a wake-up word, and may be a posterior probability output by the wake-up word detection model. The target detection probability may be a comprehensive probability that the target audio data includes at least one wake-up word, derived from the combination of at least one sub-probability for the at least one wake-up word in the target audio data.

Specifically, when the wake-up word detection model includes an audio feature extractor, an acoustic encoder, and a wake-up word predictor, the wake-up word detection apparatus can input the target audio data into the audio feature extractor to obtain corresponding target audio features. Subsequently, the target audio features are input into the acoustic encoder. Through down-sampling, preset-dimensional acoustic representation vectors of a preset number of audio frames extracted from the target audio features are defined as the target acoustic representation vectors. Both the preset number and preset dimension may be configured based on actual conditions. Afterwards, the target acoustic representation vectors can be input into the wake-up word predictor, which outputs at least one sub-detection probability for at least one wake-up word in the target audio data, leading to the determination of the target detection probability.
Step 203: determining a wake-up word detection result of the target audio data based on the target detection probability.

The wake-up word detection result may be the outcome regarding whether the audio data includes the wake-up word based on a probability determined by the wake-up word detection model. In an embodiment of the present disclosure, the wake-up word detection result may specifically indicate whether the target audio data includes any of the at least one wake-up word.

In some embodiments, the target detection probability includes at least one sub-detection probability for the at least one wake-up word in the target audio data, and determining a wake-up word detection result of the target audio data based on the target detection probability may include: acquiring at least one probability threshold corresponding to the at least one wake-up word; and in response to the sub-detection probabilities for target wake-up words in the target detection probability being greater than the corresponding probability thresholds, determining that the target wake-up words have been detected in the target audio data, the number of the target wake-up words being at least one.

The probability threshold may be a preset minimum value used to be compared with the detection probability that the audio data containing the wake-up word to determine the detection result. In an embodiment of the present disclosure, a corresponding probability threshold may be set for each wake-up word, and the probability thresholds for different wake-up words may be the same or different, depending on the specific circumstances. The target wake-up word may be defined as any wake-up word for which the sub-detection probability exceeds the probability threshold of the corresponding wake-up word, among the at least one wake-up word. The number of the target wake-up words being one or more.

After determining the target detection probability, the wake-up word detection apparatus can obtain the probability threshold corresponding to each wake-up word. For the sub-detection probability for each wake-up word of the target audio data in the target detection probability, whether the sub-detection probability exceeds the corresponding probability threshold may be determined. If yes, the wake-up word corresponding to the sub-detection probability is identified as the target wake-up word, indicating that the target wake-up word is detected in the target audio data. This process continues until all sub-detection probabilities for respective wake-up words have been determined, and the result of at least one target wake-up word detected in the target audio data are determined as the wake-up word detection result.

The wake-up word detection scheme provided in an embodiment of the present disclosure includes: acquiring target audio data; using a wake-up word detection model to detect the target audio data, and determining target detection probabilities for at least one wake-up word in the target audio data, the wake-up word detection model being obtained through the method for training the wake-up word detection model as described in the above embodiment; and determining a wake-up word detection result of the target audio data based on the target detection probabilities. By adopting the aforementioned technical scheme, the wake-up word detection model is established through stepwise training using the speech recognition model. The wake-up word detection model is then used to perform wake-up word detection on the target audio data, so as to output the detection probabilities to determine the detection result. The end-to-end stepwise training results in a wake-up word detection model without the need for post-processing, calibration, or other steps, streamlining the workflow. Additionally, due to the high accuracy and processing performance of the speech recognition model, the wake-up word detection model trained with the speech recognition model achieves a higher recall rate and fewer false awakenings, along with greater accuracy in wake-up word detection.

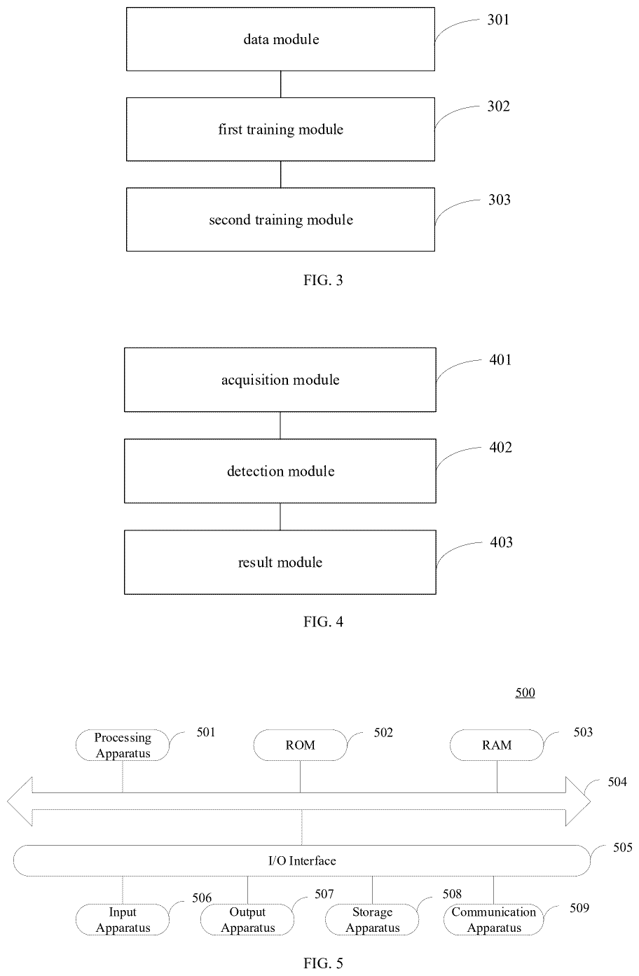

FIG. 3 is a schematic structural diagram of a training apparatus for a wake-up word detection model according to an embodiment of the present disclosure. The apparatus may be realized by software and/or hardware, and is generally integrated in an electronic device. As shown in FIG. 3, the apparatus includes:
a data module 301 for acquiring a sample dataset constructed based on at least one wake-up word, an audio dataset, and a speech recognition dataset;
a first training module 302 for using the audio dataset to perform first-stage training on an acoustic encoder in an initial model, and using the speech recognition dataset to perform first-stage training on a speech recognition model; and
a second training module 303 for obtaining a wake-up word detection model by using the sample dataset and the speech recognition model after the first-stage training to perform stepwise training on the acoustic encoder after the first-stage training, an audio feature extractor, and a wake-up word predictor in the initial model.

Optionally, the sample dataset includes a plurality of samples, and each of the samples includes sample audio data, a text label for the sample audio data, and a wake-up word label indicating whether the sample audio data contains the at least one wake-up word.

Optionally, the second training module 303 includes:
a first unit for using the sample audio data and the text labels of each sample in the sample dataset to perform second-stage training on the audio feature extractor, the acoustic encoder after the first-stage training, and the speech recognition model;
a second unit for using the sample audio data and the wake-up word label of each sample in the sample dataset to perform third-stage training on the audio feature extractor and the acoustic encoder after the second-stage training, and the wake-up word predictor in the initial model, while using the sample audio data and the text label of each sample in the sample dataset to perform third-stage training on the audio feature extractor, the acoustic encoder, and the speech recognition model after the second-stage training during the training process; and
a third unit for determining the trained initial model as the wake-up word detection model.

Optionally, the second unit is used for:
inputting the sample audio data of each sample into the audio feature extractor and the acoustic encoder after the second-stage training to output corresponding acoustic representation vectors;
inputting the acoustic representation vectors of each sample into the wake-up word predictor to output sample detection probabilities for at least one wake-up word in each piece of sample audio data; and
performing cost calculation and parameter updating based on the sample detection probabilities and the corresponding wake-up word labels of the respective samples until convergence conditions are met.

Optionally, the wake-up word detection model is used to determine detection probabilities for the at least one wake-up word in a piece of audio data.

The wake-up word detection apparatus provided by the embodiments can perform the method for training the wake-up word detection model provided by any embodiment of the present disclosure, and has corresponding functional modules for executing the method and provides relevant effects.

FIG. 4 is a schematic structural diagram of a wake-up word detection apparatus according to an embodiment of the present disclosure. The apparatus may be realized by software and/or hardware, and is generally integrated in an electronic device. As shown in FIG. 4, the apparatus includes:
an acquisition module 401 for acquiring target audio data;
a detection module 402 for using a wake-up word detection model to detect the target audio data, and determining target detection probabilities for at least one wake-up word in the target audio data, the wake-up word detection model being obtained through the method for training the wake-up word detection model as described in the above embodiment; and
a result module 403 for determining a wake-up word detection result of the target audio data based on the target detection probabilities.

Optionally, the target detection probability includes at least one sub-detection probability for the at least one wake-up word in the target audio data, and the result module 403 is used for:
acquiring at least one probability threshold corresponding to the at least one wake-up word; and in response to the sub-detection probabilities for target wake-up words in the target detection probability being greater than the corresponding probability thresholds, determining that the target wake-up words have been detected in the target audio data, the number of the target wake-up words being at least one.

The wake-up word detection apparatus provided by the embodiments of the present disclosure can perform the wake-up word detection method provided by any embodiment of the present disclosure, and has corresponding functional modules for executing the method and provides relevant effects.

An embodiment of the present disclosure also provides a computer program product, including computer programs/instructions, which, when executed by a processor, implement the method for training the wake-up word detection model and/or the wake-up word detection method in any of the embodiments of the present disclosure.

FIG. 5 is a schematic structural diagram of an electronic device according to an embodiment of the present disclosure.

FIG. 5 is specifically referred below, and it shows the structure schematic diagram suitable for achieving the electronic device 500 in the embodiment of the present disclosure. The electronic device 500 in the embodiment of the present disclosure may include but not be limited to a mobile terminal such as a mobile phone, a notebook computer, a digital broadcasting receiver, a personal digital assistant (PDA), a PAD (tablet computer), a portable multimedia player (PMP), a vehicle terminal (such as a vehicle navigation terminal), and a fixed terminal such as a digital television (TV) and a desktop computer. The electronic device shown in FIG. 5 is only an example and should not impose any limitations on the functions and use scopes of the embodiments of the present disclosure.

As shown in FIG. 5, the electronic device 500 may include a processing apparatus (such as a central processing unit, and a graphics processor) 501, it may execute various appropriate actions and processes according to a program stored in a read-only memory (ROM) 502 or a program loaded from a storage apparatus 508 to a random access memory (RAM) 503. In RAM 503, various programs and data required for operations of the electronic device 500 are also stored. The processing apparatus 501, ROM 502, and RAM 503 are connected to each other by a bus 504. An input/output (I/O) interface 505 is also connected to the bus 504.

Typically, the following apparatuses may be connected to the I/O interface 505: an input apparatus 506 such as a touch screen, a touchpad, a keyboard, a mouse, a camera, a microphone, an accelerometer, and a gyroscope; an output apparatus 507 such as a liquid crystal display (LCD), a loudspeaker, and a vibrator; a storage apparatus 508 such as a magnetic tape, and a hard disk drive; and a communication apparatus 509. The communication apparatus 509 may allow the electronic device 500 to wireless-communicate or wire-communicate with other devices so as to exchange data. Although FIG. 5 shows the electronic device 500 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 509, or installed from the storage apparatus 508, or installed from ROM 502. When the computer program is executed by the processing apparatus 501, the above functions defined in the method for training the wake-up word detection model and/or the wake-up word detection method in the embodiments of the present disclosure are executed.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any tangible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: acquire a sample dataset constructed based on at least one wake-up word, an audio dataset, and a speech recognition dataset; perform first-stage training on an acoustic encoder in an initial model with the audio dataset, and perform first-stage training on a speech recognition model with the speech recognition dataset; and obtaine a wake-up word detection model by performing stepwise training on the acoustic encoder after the first-stage training, an audio feature extractor, and a wake-up word predictor in the initial model, with the sample dataset and the speech recognition model after the first-stage training.

Alternatively, the above-mentioned computer-readable medium carries one or more programs, and when the one or more programs are executed by the electronic device, the electronic device is caused to: acquire target audio data; detect the target audio data with a wake-up word detection model, and determine target detection probabilities for at least one wake-up word in the target audio data, wherein the wake-up word detection model being obtained through the method for training the wake-up word detection model as in the embodiments of the present disclosure; and determine a wake-up word detection result of the target audio data based on the target detection probabilities.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be understood that before using the technical solutions disclosed in the embodiments of the present disclosure, the types, scope of use, usage scenarios, etc. of the information involved in the present disclosure should be informed to the user and the user's authorization should be obtained in an appropriate manner in accordance with relevant laws and regulations.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for training a wake-up word detection model, comprising:
acquiring a sample dataset constructed based on at least one wake-up word, an audio dataset, and a speech recognition dataset;
performing first-stage training on an acoustic encoder in an initial model with the audio dataset, and performing first-stage training on a speech recognition model with the speech recognition dataset; and
obtaining a wake-up word detection model by performing stepwise training on the acoustic encoder after the first-stage training, an audio feature extractor, and a wake-up word predictor in the initial model, with the sample dataset and the speech recognition model after the first-stage training.

2. The method according to claim 1, wherein, the sample dataset comprises a plurality of samples, and each of the samples comprises sample audio data, a text label for the sample audio data, and a wake-up word label indicating whether the sample audio data contains the at least one wake-up word.

3. The method according to claim 2, wherein, the obtaining the wake-up word detection model by performing stepwise training on the acoustic encoder after the first-stage training, the audio feature extractor and the wake-up word predictor in the initial model, with the sample dataset and the speech recognition model after the first-stage training comprises:
performing second-stage training on the audio feature extractor, the acoustic encoder after the first-stage training, and the speech recognition model, with the sample audio data and the text label of each sample in the sample dataset;
performing third-stage training on the audio feature extractor and the acoustic encoder after the second-stage training, and the wake-up word predictor in the initial model with the sample audio data and the wake-up word label of each sample in the sample dataset, while performing third-stage training on the audio feature extractor, the acoustic encoder, and the speech recognition model after the second-stage training with the sample audio data and the text label of each sample in the sample dataset; and
determining the trained initial model as the wake-up word detection model.

4. The method according to claim 3, wherein, the performing the third-stage training on the audio feature extractor and the acoustic encoder after the second-stage training and the wake-up word predictor in the initial model with the sample audio data and the wake-up word label of each sample in the sample dataset comprises:
inputting the sample audio data of each sample into the audio feature extractor and the acoustic encoder after the second-stage training, and outputting corresponding acoustic representation vectors;
inputting the acoustic representation vectors of each sample into the wake-up word predictor, and outputting sample detection probabilities for at least one wake-up word in each piece of sample audio data; and
performing cost calculation and parameter updating based on a sample detection probability and the corresponding wake-up word label of each sample until convergence conditions are met.

5. The method according to claim 1, wherein, the wake-up word detection model is used to determine detection probabilities for the at least one wake-up word in a piece of audio data.

6. A wake-up word detection method, comprising:
acquiring target audio data;
detecting the target audio data with a wake-up word detection model, and determining target detection probabilities for at least one wake-up word in the target audio data; and
determining a wake-up word detection result of the target audio data based on the target detection probabilities,
wherein, the wake-up word detection model being obtained through:
acquiring a sample dataset constructed based on at least one wake-up word, an audio dataset, and a speech recognition dataset;
performing first-stage training on an acoustic encoder in an initial model with the audio dataset, and performing first-stage training on a speech recognition model with the speech recognition dataset; and
obtaining a wake-up word detection model by performing stepwise training on the acoustic encoder after the first-stage training, an audio feature extractor, and a wake-up word predictor in the initial model, with the sample dataset and the speech recognition model after the first-stage training.

7. The method according to claim 6, wherein, the sample dataset comprises a plurality of samples, and each of the samples comprises sample audio data, a text label for the sample audio data, and a wake-up word label indicating whether the sample audio data contains the at least one wake-up word.

8. The method according to claim 7, wherein, the obtaining the wake-up word detection model by performing stepwise training on the acoustic encoder after the first-stage training, the audio feature extractor and the wake-up word predictor in the initial model, with the sample dataset and the speech recognition model after the first-stage training comprises:
performing second-stage training on the audio feature extractor, the acoustic encoder after the first-stage training, and the speech recognition model, with the sample audio data and the text label of each sample in the sample dataset;
performing third-stage training on the audio feature extractor and the acoustic encoder after the second-stage training, and the wake-up word predictor in the initial model with the sample audio data and the wake-up word label of each sample in the sample dataset, while performing third-stage training on the audio feature extractor, the acoustic encoder, and the speech recognition model after the second-stage training with the sample audio data and the text label of each sample in the sample dataset; and
determining the trained initial model as the wake-up word detection model.

9. The method according to claim 8, wherein, the performing the third-stage training on the audio feature extractor and the acoustic encoder after the second-stage training and the wake-up word predictor in the initial model with the sample audio data and the wake-up word label of each sample in the sample dataset comprises:
inputting the sample audio data of each sample into the audio feature extractor and the acoustic encoder after the second-stage training, and outputting corresponding acoustic representation vectors;
inputting the acoustic representation vectors of each sample into the wake-up word predictor, and outputting sample detection probabilities for at least one wake-up word in each piece of sample audio data; and
performing cost calculation and parameter updating based on a sample detection probability and the corresponding wake-up word label of each sample until convergence conditions are met.

10. The method according to claim 6, wherein, the wake-up word detection model is used to determine detection probabilities for the at least one wake-up word in a piece of audio data.

11. The method according to claim 6, wherein, the target detection probabilities comprise at least one sub-detection probability for the at least one wake-up word in the target audio data, and determining the wake-up word detection result of the target audio data based on the target detection probabilities comprises:
acquiring at least one probability threshold corresponding to the at least one wake-up word; and
in response to the sub-detection probabilities for target wake-up words in the target detection probabilities being greater than corresponding probability thresholds, determining that the target wake-up words have been detected in the target audio data, wherein the number of the target wake-up words being at least one.

12. A non-transient computer-readable storage medium having computer-executable instructions stored thereon, wherein the computer-executable instructions, when executed by a processor, cause the processor to perform a wake-up word detection method, the wake-up word detection method comprising:
acquiring target audio data;
detecting the target audio data with a wake-up word detection model, and determining target detection probabilities for at least one wake-up word in the target audio data; and
determining a wake-up word detection result of the target audio data based on the target detection probabilities,
wherein, the wake-up word detection model being obtained through:
acquiring a sample dataset constructed based on at least one wake-up word, an audio dataset, and a speech recognition dataset;
performing first-stage training on an acoustic encoder in an initial model with the audio dataset, and performing first-stage training on a speech recognition model with the speech recognition dataset; and
obtaining a wake-up word detection model by performing stepwise training on the acoustic encoder after the first-stage training, an audio feature extractor, and a wake-up word predictor in the initial model, with the sample dataset and the speech recognition model after the first-stage training.

13. The non-transient computer-readable storage medium according to claim 12, wherein, the sample dataset comprises a plurality of samples, and each of the samples comprises sample audio data, a text label for the sample audio data, and a wake-up word label indicating whether the sample audio data contains the at least one wake-up word.

14. The non-transient computer-readable storage medium according to claim 13, wherein, the obtaining the wake-up word detection model by performing stepwise training on the acoustic encoder after the first-stage training, the audio feature extractor and the wake-up word predictor in the initial model, with the sample dataset and the speech recognition model after the first-stage training comprises:
performing second-stage training on the audio feature extractor, the acoustic encoder after the first-stage training, and the speech recognition model, with the sample audio data and the text label of each sample in the sample dataset;
performing third-stage training on the audio feature extractor and the acoustic encoder after the second-stage training, and the wake-up word predictor in the initial model with the sample audio data and the wake-up word label of each sample in the sample dataset, while performing third-stage training on the audio feature extractor, the acoustic encoder, and the speech recognition model after the second-stage training with the sample audio data and the text label of each sample in the sample dataset; and
determining the trained initial model as the wake-up word detection model.

15. The non-transient computer-readable storage medium according to claim 14, wherein, the performing the third-stage training on the audio feature extractor and the acoustic encoder after the second-stage training and the wake-up word predictor in the initial model with the sample audio data and the wake-up word label of each sample in the sample dataset comprises:
inputting the sample audio data of each sample into the audio feature extractor and the acoustic encoder after the second-stage training, and outputting corresponding acoustic representation vectors;
inputting the acoustic representation vectors of each sample into the wake-up word predictor, and outputting sample detection probabilities for at least one wake-up word in each piece of sample audio data; and
performing cost calculation and parameter updating based on a sample detection probability and the corresponding wake-up word label of each sample until convergence conditions are met.

16. The non-transient computer-readable storage medium according to claim 12, wherein, the wake-up word detection model is used to determine detection probabilities for the at least one wake-up word in a piece of audio data.

17. The non-transient computer-readable storage medium according to claim 12, wherein, the target detection probabilities comprise at least one sub-detection probability for the at least one wake-up word in the target audio data, and determining the wake-up word detection result of the target audio data based on the target detection probabilities comprises:
acquiring at least one probability threshold corresponding to the at least one wake-up word; and
in response to the sub-detection probabilities for target wake-up words in the target detection probabilities being greater than corresponding probability thresholds, determining that the target wake-up words have been detected in the target audio data, wherein the number of the target wake-up words being at least one.

18. The non-transient computer-readable storage medium according to claim 12, wherein the computer-executable instructions, when executed by the processor, further cause the processor to perform a method for training a wake-up word detection model, the method for training a wake-up word detection model comprising:
acquiring a sample dataset constructed based on at least one wake-up word, an audio dataset, and a speech recognition dataset;
performing first-stage training on an acoustic encoder in an initial model with the audio dataset, and performing first-stage training on a speech recognition model with the speech recognition dataset; and
obtaining a wake-up word detection model by performing stepwise training on the acoustic encoder after the first-stage training, an audio feature extractor, and a wake-up word predictor in the initial model, with the sample dataset and the speech recognition model after the first-stage training.

19. The non-transient computer-readable storage medium according to claim 18, wherein, the sample dataset comprises a plurality of samples, and each of the samples comprises sample audio data, a text label for the sample audio data, and a wake-up word label indicating whether the sample audio data contains the at least one wake-up word.

20. The non-transient computer-readable storage medium according to claim 19, wherein, the obtaining the wake-up word detection model by performing stepwise training on the acoustic encoder after the first-stage training, the audio feature extractor and the wake-up word predictor in the initial model, with the sample dataset and the speech recognition model after the first-stage training comprises:
performing second-stage training on the audio feature extractor, the acoustic encoder after the first-stage training, and the speech recognition model, with the sample audio data and the text label of each sample in the sample dataset;
performing third-stage training on the audio feature extractor and the acoustic encoder after the second-stage training, and the wake-up word predictor in the initial model with the sample audio data and the wake-up word label of each sample in the sample dataset, while performing third-stage training on the audio feature extractor, the acoustic encoder, and the speech recognition model after the second-stage training with the sample audio data and the text label of each sample in the sample dataset; and
determining the trained initial model as the wake-up word detection model.
